(19) United States
(12) Patent Application Publication
(10) Pub. No.: US 2015/0343507 A1
(43) Pub. Date: Dec. 3, 2015

(54) BARREL TANK SEAM WELDER SYSTEM

(71) Applicants: Francis L. Deley, JR., Boardman, OH (US); Jason Garrett Lisko, Girard, OH (US); Brian Rea, Boardman, OH (US); Jeffery Bell, Newton Falls, OH (US)

(72) Inventors: Francis L. Deley, JR., Boardman, OH (US); Jason Garrett Lisko, Girard, OH (US); Brian Rea, Boardman, OH (US); Jeffery Bell, Newton Falls, OH (US)

(73) Assignee: TAYLOR-WINFIELD TECHNOLOGIES, INC., Youngstown, OH (US)

(21) Appl. No.: 14/288,605

(22) Filed: May 28, 2014

(51) Int. Cl. B21C 37/08; B23K 11/087

(52) U.S. Cl. CPC B21C 37/0822; B23K 11/0873

(57) ABSTRACT

An apparatus (10) for welding a predetermined geometrical profile shape from a sheet material (SM) includes a positioning assembly (12) including a base member (14) and a frame (16) that is operable to receive the sheet material (SM), to configure the sheet material in a predetermined orientation and to linearly translate the sheet material along a process direction (20). A guide member (18) is configured to guide a first longitudinal edge (FE) and second longitudinal edge (SE) of the sheet material (SM) into adjacent alignment along the process direction (20). A plurality of arms (50a-50e) are attached to the frame (16), each arm including a roll (52a-52e) that is configured to be translated inwardly against the associated sheet material (SM) and outwardly away from the associated sheet material to adjust a radial position of the associated sheet material. A welding assembly (60) welds a seam between the first longitudinal edge (FE) and the second longitudinal edge (SE) of the associated sheet material (SM).

### BACKGROUND

The present application relates to a system of welding material into a shape of a barrel having a geometric profile of a cylinder or tube. More particularly, this application relates to a system and a device for the orientation and longitudinal movement of sheet metal in relation to a welding apparatus for the joining of longitudinal edges of the sheet metal to create generally rounded metal bodies. However, it is to be appreciated that the described technique is also amenable to other applications such as creating various predetermined geometric profile shapes.

In one instance, barrels or drums are utilized in many industries and are required to maintain a leak tight seal to transport and store various fluid materials therein. Known methods and systems for the construction of barrels include the contortion and welding of thin wall metal material into a cylindrical or tubular orientation and subsequently providing end caps at opposing ends. Notably, barrels are not limited to generally cylindrical shaped geometric profiles. To form the outer walls of the barrel, longitudinal edges of the thin wall sheet or sheet metal are introduced into a welding apparatus such that the longitudinal edges are contorted to abut one another while the remaining sheet material is oriented into a rounded orientation. The longitudinal edges of the sheet metal are positioned in close proximity with respect to each other, are abutted and/or overlapped to create a seam. An electrical potential is applied to the seam by a welding assembly to cause welding between the longitudinal edges.

Those skilled in the art have attempted various methods including introducing the longitudinal edges of the formed sheet metal into a Z-shaped frame such as a Z-bar. The sheet metal is translated through the frame while being supported by a plurality of rollers. The longitudinal edges are abutted and a welding apparatus welds the longitudinal edges creating a weld seam.

However, known systems are subject to the rebounding, vibratory or “springy” nature of sheet metal. The translation and support of the longitudinal edges can cause “oil canning” or unwanted bending of the sheet material within the frame of the assembly. Additionally, it is a challenge to abut, align and/or overlap the longitudinal edges of the sheet material with accuracy while the sheet material is translating through the frame.

Therefore, there is a need to provide a method and a system to structurally join longitudinal edges of sheet material in the form of a cylinder, tube, barrel or other geometric profile with high accuracy. Further, there is a need to provide an assembly that can adjust the radial position and lateral position of the sheet material while the sheet material is translating through the apparatus. Additionally there is a need for a welding assembly that can be easily modified to process sheet material into cylindrical shapes of various diameters without significant loss to production due to excess machinery down time.

### SUMMARY

This application relates to an apparatus for welding a cylindrical shape from a sheet of material including a positioning assembly including a base member and a frame that is operable to receive a sheet material, to configure the sheet material in a predetermined orientation and to linearly translate the sheet material along a process direction. A guide member guides a first longitudinal edge and second longitudinal edge of the sheet material into adjacent alignment along the process direction. A plurality of arms are attached to the frame. Each arm includes a roll such that at least one of the rolls is configured to be translated inwardly against the associated sheet material and outwardly away from the associated sheet material to adjust a radial position of the associated sheet material. A welding assembly welds a seam between the first longitudinal edge and the second longitudinal edge of the associated sheet material.

In another embodiment, an apparatus for welding the sheet material into a cylindrical shape is provided. The apparatus comprises a positioning assembly including a base member and a frame that is operable to receive the sheet material, to configure the sheet material in a predetermined orientation, and to translate the sheet material along a process direction. The base member includes a guide member configured to guide the first longitudinal edge and the second longitudinal edge of the sheet material into adjacent alignment along the process direction. The guide member includes a body, a first channel for receiving a first longitudinal edge of the associated sheet material, and a second channel for receiving a second longitudinal edge of the sheet material. The first channel and the second channel each include a distal end and an opposite proximal end. The associated sheet material is configured to be received at the distal ends and guided into adjacent alignment at the proximal ends.

The frame includes a frame surface having an opening to receive the associated sheet material from the base member along the process direction. A plurality of arms are attached to the frame surface. Each arm includes a roll such that at least one arm is configured to be translated inwardly against the sheet material and outwardly away from the sheet material to adjust a radial position of the sheet material. A welding assembly welds a seam between the first longitudinal edge and the second longitudinal edge of the sheet material forming a cylindrical shape.

In yet another embodiment, a method of welding the sheet material into a cylindrical shape includes initially translating the sheet material along a process direction. A first longitudinal edge of the sheet material is received within a first channel of a guide member and a second longitudinal edge of the sheet material is received within a second channel of the guide member. The sheet material is positioned within a frame having a plurality of arms positioned radially around a circumference of the sheet material. A radial position of the sheet material is adjusted by translating the plurality of arms inwardly against the sheet material or outwardly away from the sheet material as the sheet material is translated along the process direction. The first longitudinal edge is welded to the second longitudinal edge. Additionally, in another embodiment, at least one of the first channel and second channel can be adjusted to position the first longitudinal edge relative to the second longitudinal edge of the sheet material to adjust an amount of edge overlap prior to welding.

One advantage resides in quality, radial and lateral adjustability of the sheet material prior to and/or as it is translated along the process direction.

Another advantage resides in the ability to make these adjustments prior to and/or as the sheet material is being translated and welded.

Another advantage resides in the ability to easily remove and replace the rolls of the arms to accommodate a range of cylindrical sizes.

Still other features and benefits of the present disclosure will become apparent from the following detailed descriptions.

### BRIEF DESCRIPTION OF THE DRAWINGS

FIG. 1 is a side elevation view of one embodiment of the welding apparatus according to the present application;

FIG. 2 is a top view of the welding apparatus of FIG. 1;

FIG. 3 is a front view of the welding apparatus of FIG. 1;

FIG. 4A is a perspective view of a guide member of the welding apparatus of FIG. 1 according to the present application;

FIG. 4B is a cross sectional view of the guide member of the welding apparatus of FIG. 4A according to the present application;

FIG. 5 is a perspective view of a plurality of servo-mechanical arms connected to contoured rolls attached to a frame of the welding apparatus of FIG. 1 according to the present application;

FIG. 6 is a perspective view of the plurality of servo-mechanical arms attached to the frame of the welding apparatus of FIG. 1 wherein one contoured roll is disconnected from the frame according to the present application;

FIG. 7 is a perspective view of another embodiment of the welding apparatus according to the present disclosure;

FIG. 8 is a top plan view of the welding apparatus of FIG. 7;

FIG. 9 is a perspective view of a portion of sheet material;

FIG. 10 is a flow chart of a method of welding the sheet material into a predetermined geometric profile shape such as a cylindrical shape; and

FIG. 11 is a flow chart of a method of controlling an apparatus for welding a sheet material into a predetermined geometric profile shape such as a cylindrical shape.

### DETAILED DESCRIPTION

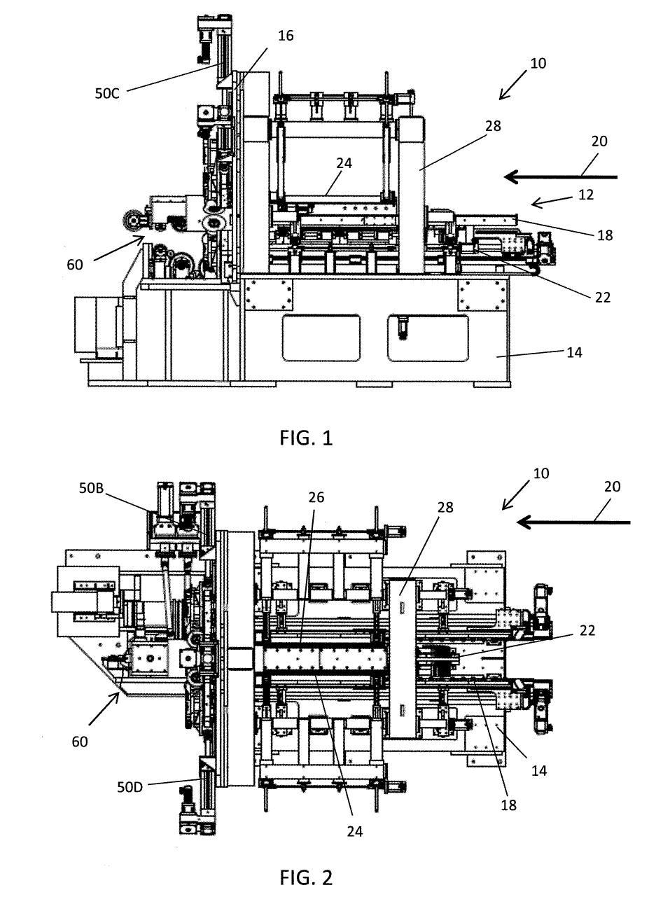

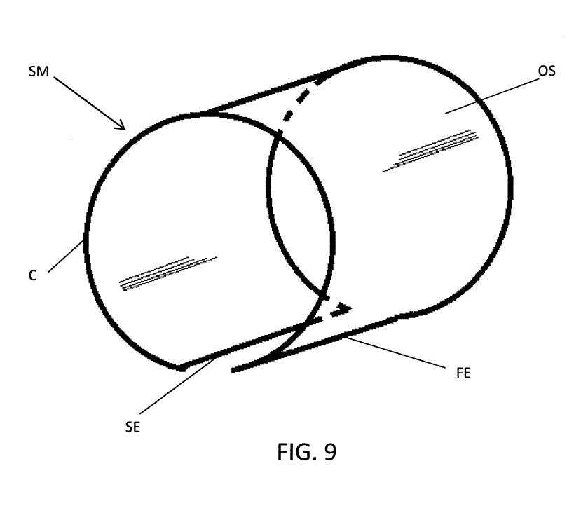

In accordance with the present disclosure, an apparatus and method for welding sheet metal into a predetermined geometric profile shape such as an elongated cylindrical shape is provided. As shown in FIG. 1, a welding apparatus 10 for welding a cylinder shape from a sheet material SM (See FIG. 9) is configured to continuously shape and weld a strip of sheet material such as metal or steel from a suitable supply such as a coil or blanks (not shown). The apparatus 10 includes a positioning assembly 12 having a base member 14 and a frame 16. The positioning assembly is operable to receive the sheet material, configure the sheet material in a predetermined orientation such as a generally rounded or cylindrical orientation and translate the sheet material along a process direction 20. As illustrated by FIG. 1, the process direction 20 is from the right hand side of the apparatus 10 towards the left hand side of the apparatus 10 as illustrated by the directional arrow 20.

A guide member 18 is attached to the base member 14 that is configured to guide a first longitudinal edge FE (FIG. 9) and second longitudinal edge SE (FIG. 9) of the sheet material into adjacent alignment along the process direction 20. Additionally, as illustrated by FIG. 2, the base member 14 includes a track 22 that is configured to translate the sheet material along the process direction 20 and a pair of longitudinal arms 24, 26 extend from support members 28 and can be adjustable to press against a top portion of the sheet material. The arms 24, 26 and support members 28 can be adjusted as necessary to process the sheet material into the desired predetermined geometric profile shape. As the term, “predetermined geometric profile shape” is used herein, it generally refers to the cross sectional shape of the sheet material. In the preferred embodiments, this shape is generally cylindrical. However, the arms 24, 26 support member 28 and frame 16 can be configured to process various profile shapes such as oval or multi sided polygon type shapes and this application is not limited in this regard.

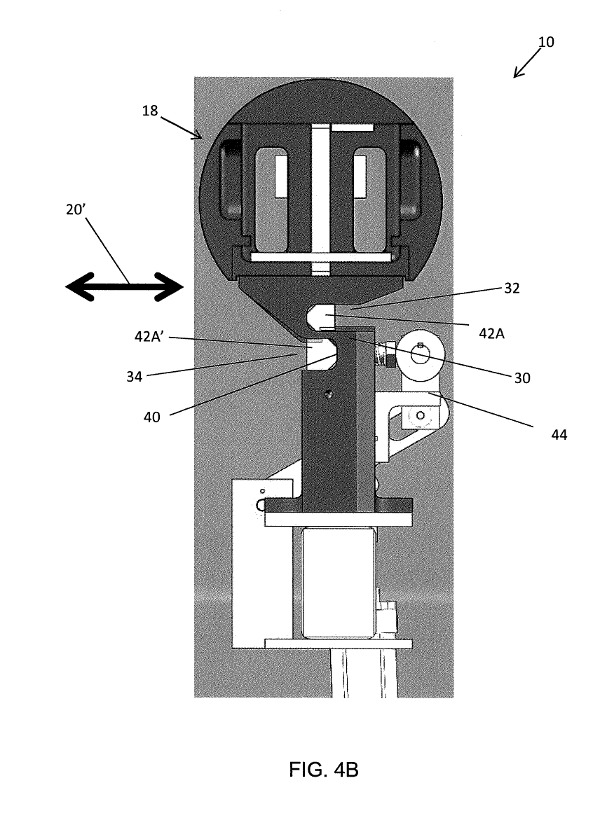

As illustrated by FIGS. 4A and 4B, the guide member 18 of the assembly 10 includes an elongated body 30 having a first channel 32 for receiving the first longitudinal edge FE of the sheet material and a second channel 34 for receiving the second longitudinal edge SE of the sheet material. The elongated body 30 can be generally referred to as a Z-bar as the first channel 32 and second channel 34 are elongated and positioned along opposing sides of the elongated body 30. Each channel includes a distal end 36 and an opposite proximal end 38 wherein the sheet material SM is configured to be received at the distal ends 36 and guided into adjacent alignment at the proximal ends 38. As illustrated by FIG. 4B, the first channel 32 and second channel 34 include a generally U-shaped profile 40 defining a gap wherein the first and second longitudinal ends of the sheet material are received within the gap as it is translated along the process direction 20.

FIG. 4A illustrates the first and second channels 32, 34 can include a plurality of elongated segments 42a, 42b, 42c and 42d such that each segment 42a-d is configured to be movable relative to the body 30 of the guide member 18 to adjust a lateral position of the first and second longitudinal edges of the sheet material. FIG. 4B shows elongated segment 42a′ as it is positioned along the second channel 34 relative to elongated segment 42a as it is positioned along the first channel 32.

In one embodiment, a cam assembly 44 is attached to the base member 14 and the plurality of segments 42a-42d such that the rotation of the cam assembly causes individual lateral movement of the segments 42a-d relative to the body 30 of the guide member 18. Slight movements of the segments adjust the sheet material such that the first and second longitudinal edges can be moved in close alignment as the sheet material translates along the process direction. The elongated segments 42a, 42a′ are configured to move in a lateral direction 20′ relative to the body 30 as illustrated by the directional arrow in FIG. 4B.

The cam assembly 44 can be automatically operated by a controller 80 that is configured to control the welding apparatus 10 such that the plurality of elongated segments 42a-42d are automatically movable relative to the body 30 of the guide member 18 to adjust the lateral position of the first and second longitudinal edges of the sheet material as the sheet material is linearly translated along the process direction 20. In one embodiment, the controller 80 receives a signal from a sensor 82 which senses alignment at one or more points along the base member 14. Exemplarily sensors include but are not limited to electromechanical actuator feedback, LASER gauging structures, electro-optical sensors, fiber-optic sensors, mechanical sensors (such as linear, angular, rotation, and magnetic position sensors) and the like. The signal indicates the relative alignment of the first and second longitudinal edges of the sheet material at a position between the distal end 36 and proximal end 38 of the guide member 18. The controller 80 directs the cam assembly 44 to rotate and laterally shift the particular segments 42a-42d to align the first and second longitudinal edges of the sheet material within the U-shaped profiles 40. This allows an amount of overlap between the first and second longitudinal edges to be adjusted.

In one embodiment, the U-shaped profile 40 of each segment 42a-42d is generally tapered. In another embodiment, the U-shape profile 40 of each segment 42a-42d are also in general alignment such that the segment 42d adjacent the distal end 36 includes a first profile shape 46 and the segment 42a adjacent the proximal end 38 includes a second profile shape 48 such that the first profile shape 46 has a generally wider channel 40 than the second profile shape 48.

As illustrated by FIGS. 1-3, 5, 6, 7 and 8 the welding apparatus 10 also includes a plurality of servo mechanical arms 50a, 50b, 50c, 50d and 50e that are attached to the frame 16. Each of the plurality of arms 50a-50e include contoured rolls 52a, 52b, 52c, 52d and 52e, respectively attached to each arm. In one embodiment, the arms are configured to translate inwardly towards the sheet material and outwardly away from the sheet material SM while the rolls are in contact with an outer surface OS of the sheet material to radially adjust the position of the sheet material. In this embodiment, arms 50b, 50c and 50d are configured for radial translation while arms 50a and 50e are static. However, this disclosure is not limited to the arrangement and configuration of static and movable arms as any combination of movable and static arms are contemplated.

In one embodiment, the frame 16 includes a frame surface 17 having an opening 19 to receive the associated sheet material from the base member 18 along the process direction. The plurality of arms 50a-50e are attached to the frame surface 17, aligned along a common plane on the frame 16 and are radially spaced about the opening 19 in the frame 16. In one embodiment, the movement of the plurality of contoured rolls 52b-52d are controlled by the controller 80. The controller 80 receives a signal from the sensor 82 mounted to the frame 16 or base member 14. The controller 80 sends a signal to the plurality of servo mechanical arms 50b, 50c and 50d to automatically translate inwardly against a circumference C of the sheet material SM and outwardly away from the circumference C of the sheet material SM to adjust the radial position of the sheet material prior to and/or as it is being translated along the process direction 20.

In one embodiment, the rolls 52a-52e can be hourglass type rolls. However, various shaped rolls can be utilized to assist with processing the sheet material into various predetermined geometric profile shapes and this application is not limited to hourglass shaped rolls for processing cylindrical shapes. The rolls 52a-52e are connected to the arms 50a-50e by structural roller plates 62a, 62b, 62c, 62d and 62e, respectively, that allows the rolls to be individually removed and replaced without having to remove other structural members of the apparatus 10, such as the frame 16, the pair of longitudinal arms 24, 26, the support members 28 or the plurality of arms 50a-50e. This feature allows a user to easily switch out the rolls without having to experience long durations of process shutdown. The rolls can be removed and replaced with various types of rolls that have different shapes and dimensions to process sheet material SM into cylindrical shapes of various diameters. In one embodiment, the nominal diameter of the SM is between about 12″ and 30″. In particular, the welding apparatus 10 is configured to process sheet material SM into a cylindrical shape having a desired nominal diameter of about 14″ (355.6 mm), 16″ (406.4 mm), 18″ (457.2 mm), 20″ (508 mm), 22″ (558.8 mm), and 24″ (609.6 mm) or other standard metric dimensions such as 350 mm, 400 mm, 450 mm, 510 mm, 560 mm, and 610 mm.

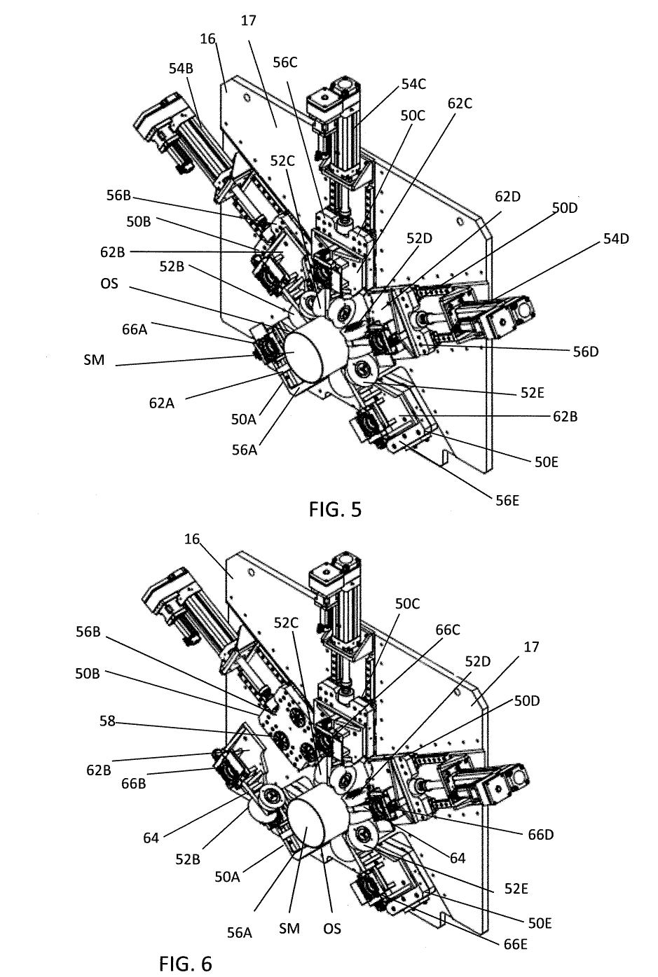

As illustrated by FIGS. 5 and 6, servo mechanical members 54b, 54c and 54d are attached to connection plates 56b, 56c and 56c included with the arms 50b, 50c and 50d, respectively. In this embodiment, the arms 50a and 50e do not have a servo mechanical member but do include connection plates 56a and 56e. The servo mechanical members 54b, 54c and 54d of the arms 50b, 50c and 50d are configured to radially translate the rolls 52b, 52c and 52d, respectively, between about 6″ (15 cm) to about 12″ (30 cm) and more particularly about 9″ (22.5 cm) to about 10″ (25 cm). The range distance translated can accommodate the change in roll arms for different nominal diameter types such as the diameter types previously identified and provides enough length to allow for fine adjustment during a particular size process run.

The connection plates 56a-56e each include a plurality of connection points 58 that are configured to align with and connect the roller plates 62a-62e to the connection plates 56a-56e. The roller plates 62a-62e are directly connected to and support the rollers. Each roller plate includes a connection element or beam 64 that directly supports the roll 52a-52e to the roller plate 62a-62e. The connection beam 64 can have various lengths depending on the desired diameter the tube into which the sheet material is to be processed.

In one embodiment, the connection points 58 are generally annular or puck shaped pneumatic members, such as a workholding system provided by Erowa LTD, and are configured to attach and disconnect from the roller plates through air pressure provided by a pneumatic system (not shown). The roller plates 62a-62e include an attachment ring 66a-66e positioned along the roller plates 62a-62e, respectively, opposite from the connection points 58. The attachment rings 66a-66e can be an end effector or other robotic tool changer such as those provided by ATI Industrial Automation. In this embodiment, the servo mechanical members 54b, 54c and 54d are operable to radially translate the connection plates 56b-56d, the roller plates 62b-62d, the connection beams 64 and the rolls 52b-52d to abut against the outer surface OS of the sheet material SM and adjust a radial position of the sheet material as it is translating along the process direction.

As illustrated by FIG. 6, the roll 52b and roller plate 62b are removed from the connection plate 56b of arm 50b.

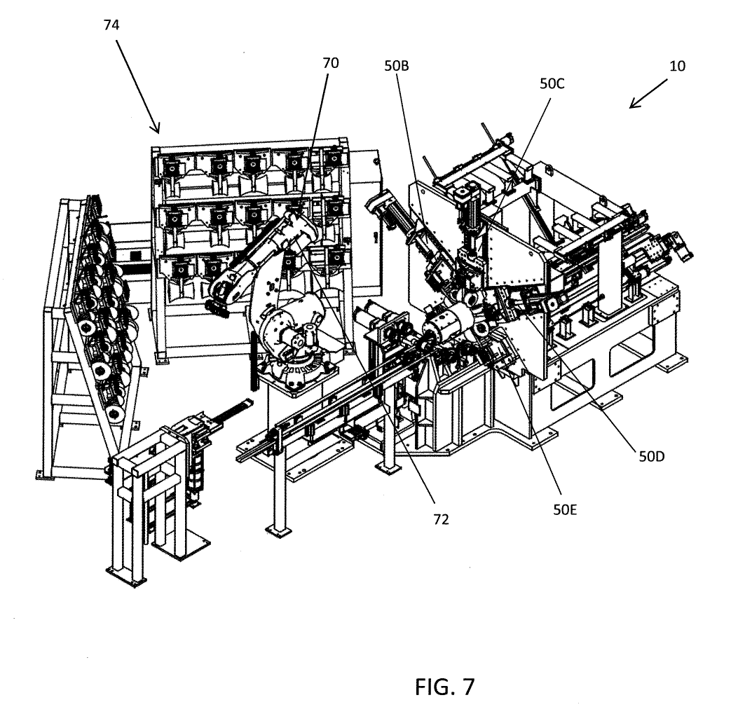

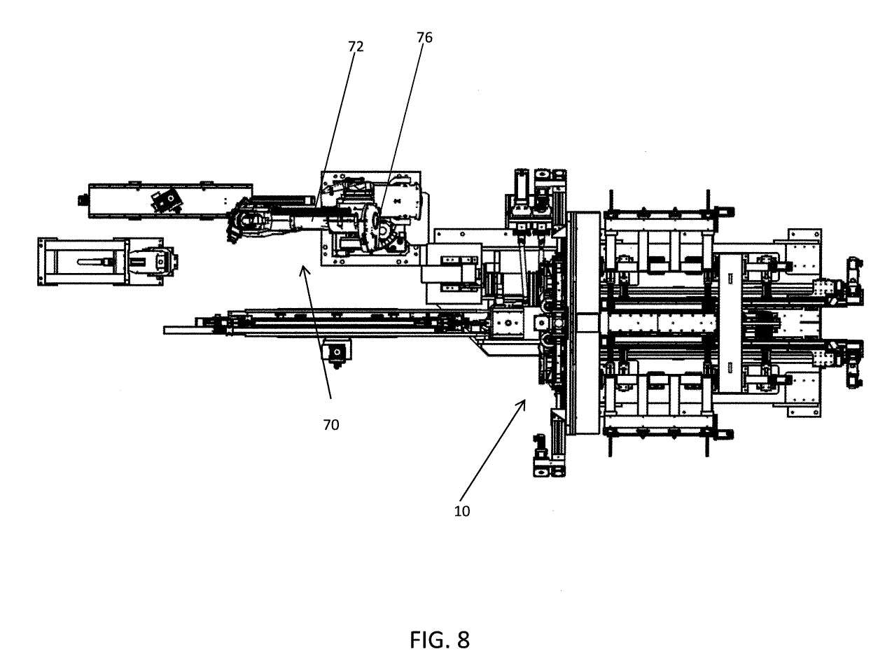

In the embodiment illustrated by FIGS. 7 and 8, the rolls 52a-52e, roller plates 62a-62e, and connector beams 64 can be removed from the respective arms 50a-50e by a robot 70. The robot 70 includes a robot element or arm 72 having an attachment end 76 configured to attach to attachment rings 66a-66e to remove the rolls 52a-52e and roll plates 62a-62e from the connection plates 56a-56e, which remain on the frame 16. The robot arm 72 can grab a different roll from a roll storage rack 74 having a different size roll and/or different length connector beam 64 and connect it to the connector plates 56a-56e. Additionally, the robot 70 is configured to remove the welded sheet material from the system and place it on auxiliary equipment to remove excess weld material or “toenails” as needed and to brush or continue machining the sheet material. The welded sheet material can optionally be offloaded by the robot 70 onto another conveyor.

A welding assembly 60 (as illustrated by FIGS. 1-3) is provided downstream of the guide member 18 (as illustrated by FIG. 4A) and the plurality of arms 50a-50e for welding a seam between the first longitudinal edge FE and the second longitudinal edge SE of the sheet material. (See FIG. 9) In one embodiment, the welding assembly 60 is configured to provide a weld along the edges in accordance with a method of joining metal sheet or strip described by U.S. Pat. No. 3,301,994 or U.S. Pat. No. 5,676,862, both of which are incorporated herein in their entirety. However, this application is not limited to these welding methods. The welding assembly 60 is positioned adjacent to and in alignment with the proximal end 38 of the first and second channels 32, 34.

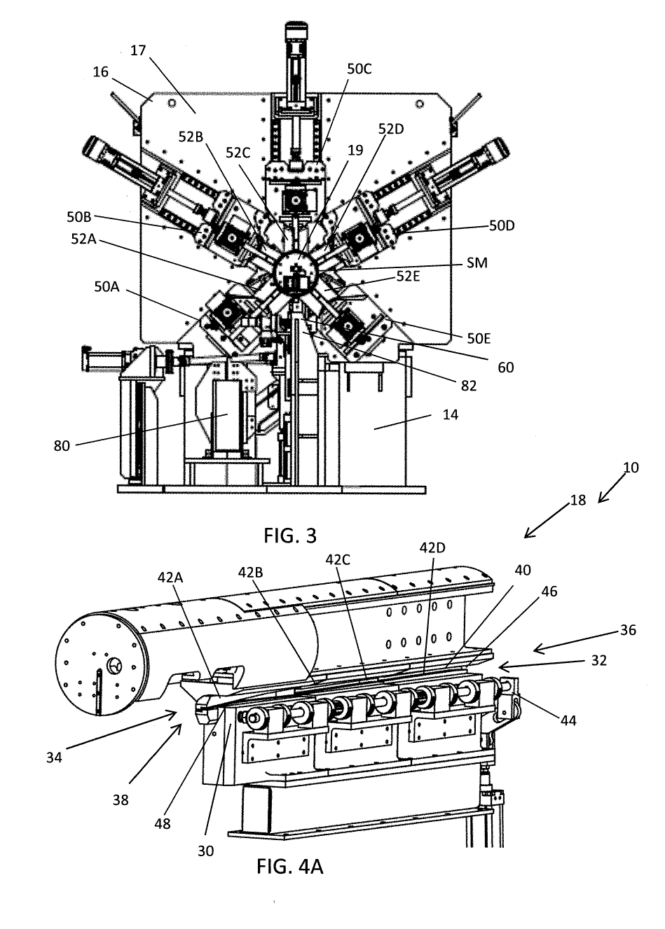

In one embodiment, the seam includes specific alignment with the first longitudinal edge and the second longitudinal edge to ensure a smooth, straight weld that is not susceptible to leakage. More particularly, the seam is created by an overlap of the first longitudinal edge FE and the second longitudinal edge SE (FIG. 9). It is preferred that the amount of overlap is approximately equal to the thickness of the sheet material. In one embodiment, at least one sensor 82 can be installed adjacent to the proximal end 38 of the guide member 18 to identify the tolerance of the overlap. The sensor 82 can relay this signal to the controller 80 (FIG. 3), such as one or more computer processors, to perform adjustments to the lateral and radial positions of the sheet material by movement of the segments 42a-42d and/or movement of the arms 50b-50d. Additionally, the first channel 32 can be located above the second channel 34 and be arranged to position the first longitudinal edge FE in overlap relation to the second longitudinal edge SE as the sheet material translates along the process direction 20.

The system controller 80 controls a voltage source to apply an electric potential to the plurality of servo mechanical arms 50b-50d and the guide member 18. In one embodiment, the controller 80 includes one or more processors that is programmed to control the position of the first longitudinal edge FE relative to the second longitudinal edge SE. The controller 80 is also programmed to adjust a variable voltage source to provide the electrical potential that is introduced to the welding member 60 and the amount of both a voltage magnitude, ie. high or low, and the amount of amperage draw throughout the duration of the welding process. Additionally, the controller 80 is programmed to control the rate of translation of the sheet material as it is translated along the process direction 20 and the robot 70.

The amount of power required to by the welding apparatus 10 is in part dependent on the thickness of the sheet material SM to be welded. In particular, as the thickness of the sheet material SM increases, the amount of electrical potential also increases.

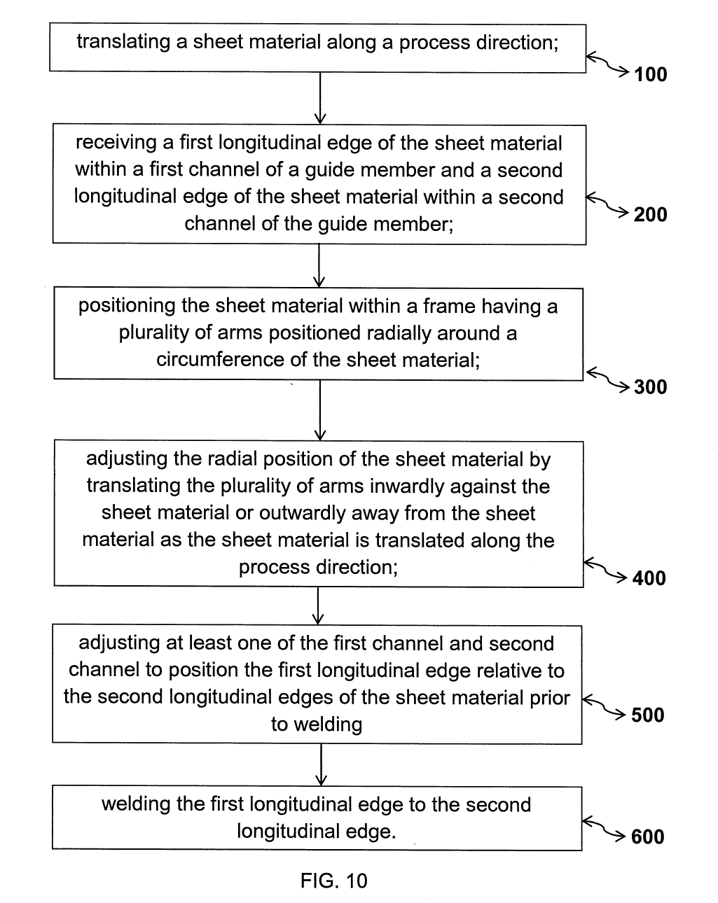

In operation, the sheet material SM is translated along a process direction 20 in a step 100, as illustrated by the flowchart of FIG. 10. In one embodiment, the sheet material SM is formed into a generally circular cross sectional shape prior to engaging the welding apparatus 10. In another embodiment, the welding apparatus 10 can include the framework structure that forms the sheet material SM into a generally circular cross sectional shape to allow the sheet material SM to be received within the guide member 18 of the welding apparatus 10. In a step 200, the first longitudinal edge FE of the sheet material SM is received within a first channel 32 of the guide member 18 and the second longitudinal edge SE of the sheet material SM is received within the second channel 34 of the guide member 18. In a step 300, the sheet material SM is positioned within the frame 16 with the plurality of arms 50 positioned radially around the circumference C of the sheet material SM. In a step 400, a radial position of the sheet material SM is adjusted by translating at least one of the plurality of arms 50 inwardly against the sheet material or outwardly away from the sheet material as the sheet material is translated along the process direction 20. In a step 600, the first longitudinal edge LE is welded to the second longitudinal edge SE.

Additionally, in a step 500, at least one of the first channel 32 and second channel 34 can be adjusted to position the first longitudinal edge FE relative to the second longitudinal edge SE of the sheet material prior to the welding step 600. The sensor 82 is in electronic communication with the controller 80, and is configured to detect the position of the first longitudinal edge FE relative to the second longitudinal edge SE.

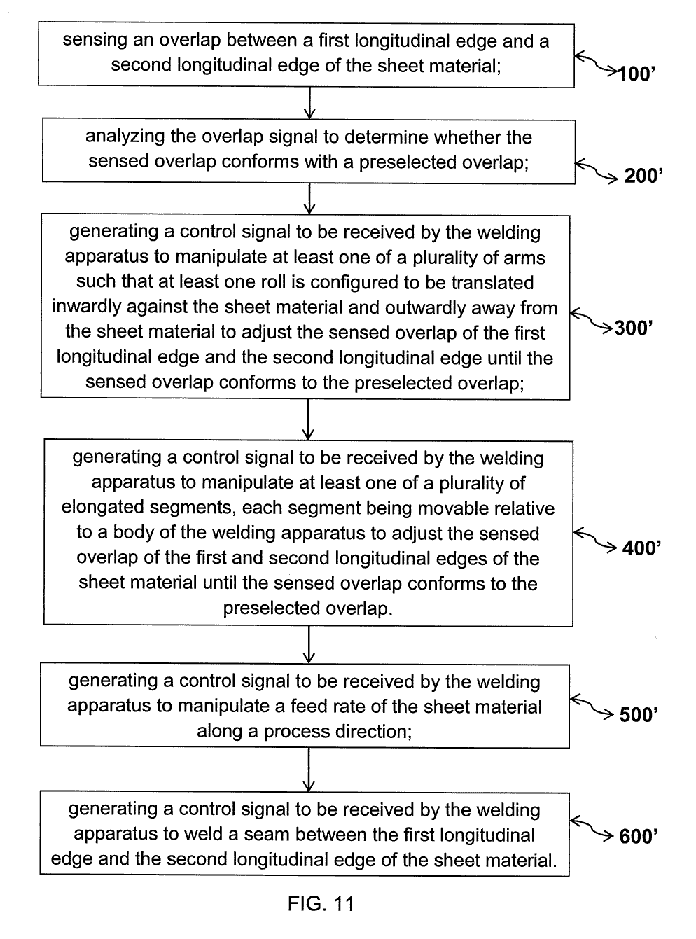

FIG. 11 illustrates a flow chart of a method of controlling the apparatus 10 for welding the sheet material SM into a cylindrical shape. In step 100′, an overlap between the first longitudinal edge FE and a second longitudinal edge SE is sensed by the sensor 82 and received by the controller 80. The signal is indicative of the positions or relative positions of the first and second longitudinal edges. Alternatively, the signal could be input manually by an operator at the controller 80. In a step 200′, the controller 80 is configured to analyze the overlap signal and determine whether the sensed overlap of the first longitudinal edge and the second longitudinal edge are positioned in an overlapping manner sufficient to establish an alignment for a welded seem. For example, the controller compares the sensed overlap with a preselected or programmed overlap. In a step 300′, the controller 80 generates a control signal to be received by the welding apparatus to manipulate one or more of the arms 50 as necessary, to position the first and second edges with the preselected overlap. In a step 400′, the controller 80 generates a control signal to be received by the welding apparatus to manipulate one or more of the plurality of segments 42 located along the guide member 18 as necessary, to adjust the sensed overlap of the first and second longitudinal edges of the sheet material until the sensed overlap conforms to the preselected overlap. Either step 300′ or 400′ can be utilized but are optional so long as the sensed overlap conforms with the preselected overlap.

In a step 500′, the controller 80 generates a control signal to be received by the welding apparatus to manipulate the feed rate of the sheet material along the process direction 20. In a step 600′, the controller 80 generates a control signal to be received by the welding apparatus 10 to control a welding voltage and amperage of the welding assembly 60 to weld the first and second longitudinal edges together forming the sheet material into a cylinder or tube forming a seam there between. This system and welding apparatus 10 allows many cylindrical shapes to be welded from sheet material without the risk of extended mechanical downtime. Additionally, the rolls 52 can be quickly replaced to convert the welding apparatus 10 to weld a cylindrical shape of a different diameter without having to remove other structural members of the system. The controller 80 is also configured to generate a control signal to manipulate the robot 70 and robot arm 72 to remove and to mount various sizes of rolls 52.

The exemplary embodiment has been described with reference to the preferred embodiments. Obviously, modifications and alterations will occur to others upon reading and understanding the preceding detailed description. It is intended that the exemplary embodiment be construed as including all such modifications and alterations insofar as they come within the scope of the appended claims or the equivalents thereof.

1. An apparatus for welding a predetermined geometric profile shape from an associated sheet material comprising:
a positioning assembly including a base member and a frame that is operable to receive the associated sheet material, configure the associated sheet material in a predetermined orientation and translate the associated sheet material along a process direction;
a guide member attached to the base member that is configured to guide a first longitudinal edge and a second longitudinal edge of the associated sheet material into adjacent alignment along the process direction;
a plurality of arms attached to the frame, each arm including a roll wherein at least one roll is configured to be translated inwardly against the associated sheet material and outwardly away from the associated sheet material to adjust a radial position of the associated sheet material; and
a welding assembly for welding a seam between the first longitudinal edge and the second longitudinal edge of the associated sheet material.

2. The welding apparatus of claim 1, wherein the guide member includes a body having a first channel configured for receiving the first longitudinal edge of the associated sheet material and a second channel configured for receiving the second longitudinal edge of the associated sheet material, the first channel and second channel each include a distal end and a opposite proximal end wherein the associated sheet material is configured to be received at the distal ends and guided into adjacent alignment at the proximal ends.

3. The welding apparatus of claim 2 wherein at least one of the first channel and second channel includes a generally tapered U-shaped profile such that the distal end includes a first profile shape and the proximal end includes a second profile shape such that the first profile shape has a generally wider channel than the second profile shape.

4. The welding apparatus of claim 2, wherein at least one of the first and second channels includes a plurality of elongated segments, each segment is configured to be movable relative to the body of the guide member to adjust a lateral position of the first and second longitudinal edges of the associated sheet material.

5. The welding apparatus of claim 4, further including:
a controller that is configured to control the welding apparatus such that the plurality of elongated segments are automatically movable relative to the body of the guide member to adjust the lateral position of the first and second longitudinal edges of the associated sheet material as the associated sheet material is linearly translated along the process direction.

6. The welding apparatus of claim 1, wherein the plurality of arms are aligned along a common plane on the frame and are radially spaced about a circumference of the associated sheet material.

7. The welding apparatus of claim 1, further including:
a controller that is configured to control the welding apparatus such that at least one of the plurality of rolls can be automatically translated inwardly against the associated sheet material and outwardly away from the associated sheet material to adjust the radial position of the associated sheet material as the associated sheet material is translated along the process direction.

8. The welding apparatus of claim 1, further including:
a sensor configured to sense an overlap of the first longitudinal edge relative to the second longitudinal edge of the associated sheet material and generate an overlap signal.

9. The welding apparatus of claim 8 further comprising:
a controller configured to:
receive the overlap signal,
analyze the overlap signal to determine whether the sensed overlap conforms with a preselected overlap,
control the arms to translate the rolls inwardly or outwardly until the sensed overlap conforms to the preselected overlap,
control the welding apparatus to weld the first and second longitudinal edges in coordination with advancement of the associated sheet material as it translates along the process direction.

10. The welding apparatus of claim 1 wherein the rolls are individually removable from the arms.

11. The welding apparatus of claim 10 wherein at least one of the plurality of arms include a servo mechanical member attached to a connection plate having at least one connection point configured to attach to a roller plate, the roller plate having a connection element configured to connect to the roll.

12. The welding apparatus of claim 11 further including:
a robot having a robot element that is configured to remove the roller plate from the connection plate on the frame of the welding apparatus.

13. The welding apparatus of claim 11 further including:
a robot having a robot arm that is configured to remove the roller plate from the connection plate and mount another roller plate carrying a roll of a different size to the connection plate on the frame of the welding apparatus.

14. A method of controlling an apparatus for welding a sheet material into a predetermined geometric profile shape, the method comprising:
sensing an overlap between a first longitudinal edge and a second longitudinal edge of the sheet material;
analyzing the overlap signal to determine whether the sensed overlap conforms with a preselected overlap;
generating a control signal to be received by the welding apparatus to manipulate at least one of a plurality of arms attached to a frame wherein each arm includes a roll such that at least one roll is configured to be translated inwardly against the sheet material and outwardly away from the sheet material to adjust the sensed overlap of the first longitudinal edge and the second longitudinal edge until the sensed overlap conforms to the preselected overlap; and
generating a control signal to be received by the welding apparatus to weld a seam between the first longitudinal edge and the second longitudinal edge of the sheet material.

15. The method of controlling the welding apparatus of claim 14 further including:
generating a control signal to be received by the welding apparatus to manipulate at least one of a plurality of elongated segments configured in relative alignment to receive the first longitudinal edge and the second longitudinal edge of the sheet material, each segment being movable relative to a body of the welding apparatus to adjust the sensed overlap of the first and second longitudinal edges of the sheet material until the sensed overlap conforms to the preselected overlap.

16. The method of controlling the welding apparatus of claim 14 further including:
generating a control signal to be received by the welding apparatus to manipulate a robot configured to remove at least one of the plurality of rolls from the arms on the frame of the welding apparatus.

17. The method of controlling the welding apparatus of claim 14 further including:
generating a control signal to be received by the welding apparatus to manipulate a robot configured to remove at least one of the plurality of rolls from one of the arms on the frame of the welding apparatus, retrieve a different roll of a different size, and mount the roll of the different size to the one of the arms.

18. The method of controlling the welding apparatus of claim 14 further including:
generating a control signal to be received by the welding apparatus to manipulate a feed rate of the sheet material along a process direction.

19. A method of welding a sheet material into a predetermined geometrical profile shape, the method comprising:
translating a sheet material along a process direction;
receiving a first longitudinal edge of the sheet material within a first channel of a guide member and a second longitudinal edge of the sheet material within a second channel of the guide member;
positioning the sheet material within a frame having a plurality of arms positioned radially around an outer surface of the sheet material;
adjusting the radial position of the sheet material by translating at least one of the plurality of arms inwardly against the sheet material or outwardly away from the sheet material as the sheet material is translated along the process direction; and
welding the first longitudinal edge to the second longitudinal edge.

20. The method according to claim 19 further comprising adjusting at least one of the first channel and second channel to position the first longitudinal edge relative to the second longitudinal edges of the sheet material prior to welding.

21. An apparatus for welding an associated sheet material comprising:
a positioning assembly including a base member and a frame that is operable to receive the associated sheet material, configure the associated sheet material into a predetermined geometrical profile shape and translate the associated sheet material along a process direction;
a guide member attached to the base member that is configured to guide a first longitudinal edge and second longitudinal edge of the associated sheet material into adjacent alignment along the process direction, wherein the guide member includes a body having a first channel configured for receiving the first longitudinal edge of the associated sheet material and a second channel configured for receiving the second longitudinal edge of the associated sheet material, the first channel and second channel each include a distal end and a opposite proximal end wherein the associated sheet material is configured to be received at the distal ends and guided into adjacent alignment at the proximal ends, wherein at least one of the first and second channels includes a plurality of elongated segments, each segment is configured to be movable relative to the body of the guide member to adjust a lateral position of the first and second longitudinal edges of the associated sheet material;
a plurality of arms attached to the frame, each arm including a roll for supporting the associated sheet material; and
a welding assembly for welding a seam between the first longitudinal edge and the second longitudinal edge of the associated sheet material.

22. The apparatus of claim 21, wherein at least one roll is configured to be translated inwardly against the associated sheet material and outwardly away from the associated sheet material to adjust a radial position of the associated sheet material.
